(19) United States
(12) Patent Application Publication
(10) Pub. No.: US 2018/0351163 A1
(43) Pub. Date: Dec. 6, 2018

(54) STABILIZED LITHIUM COBALT OXIDE SPINEL ELECTRODES FOR LITHIUM BATTERIES

(71) Applicant: UCHICAGO ARGONNE, LLC, Chicago, IL (US)

(72) Inventors: Michael M. THACKERAY, Naperville, IL (US); Eungje LEE, Naperville, IL (US); Jason R. CROY, Plainfield, IL (US)

(73) Assignee: UCHICAGO ARGONNE, LLC, Chicago, IL (US)

(21) Appl. No.: 15/793,577

(22) Filed: Oct. 25, 2017

Related U.S. Application Data
(60) Provisional application No. 62/514,086, filed on Jun. 2, 2017.

(51) Int. Cl. H01M 4/1315; H01M 10/0525; H01M 4/505

(52) U.S. Cl. CPC H01M 4/1315; H01M 4/505; H01M 10/0525

(57) ABSTRACT

Cation-stabilized materials and compositions are described herein, which suppress the structural and electrochemical instability of lithium-cobalt-oxide spinel and lithiated lithium-cobalt-oxide spinel electrodes for lithium batteries, notably lithium-ion batteries. These stabilized lithiated spinel materials are attractive as positive electrodes for lithium batteries in their own right or when used as a structural component to stabilize layered metal oxide electrode systems, such as a two-component ‘layered-spinel’ system or a multi-component ‘layered-spinel’ system, as defined by the phase diagram and compositional space of each system.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to electrode materials for lithium electrochemical cells and batteries. Such cells and batteries are used widely to power numerous devices, for example, portable electronic appliances and medical, transportation, aerospace, and defense systems.

### BACKGROUND

State-of-the-art lithium batteries do not provide sufficient energy to power electric vehicles for an acceptable driving range. This limitation arises because the electrodes, both the anode, typically graphite, and the cathode, typically layered LiMO₂ (in which M is a metal cation, for example, Mn, Co, Ni or a combination thereof), spinel LiMn₂O₄ and olivine LiFePO₄ materials do not provide a sufficiently high cell capacity or voltage to meet the energy demands. Approaches that are currently being adopted to enhance the energy of lithium-ion batteries include the exploitation of composite cathode structures that can be formulated in terms of two layered components, xLi₂MnO₃·(1-x)LiMO₂ (in which M is typically Mn, Ni, Co or a combination thereof; and 0<×<1), which offer a significantly higher capacity compared to conventional layered, spinel and olivine cathode materials. Such composite structures are often referred to as ‘layered-layered’ materials.

Lithium-rich and manganese-rich high capacity cathodes, such as xLi₂MnO₃·(1-x)LiMO₂ (M=Mn, Ni, Co) materials suffer from ‘voltage fade’ on repeated cycling, which reduces the energy output and efficiency of the cell, thereby compromising the management of cell/battery operation. Relative to nickel-rich LiMO₂ (M=Ni, Mn, and Co, often referred to as ‘NMC’) electrodes, manganese-rich electrodes are more attractive from the viewpoint of being lower cost and safer materials. Advances have been made by adding a third (spinel) component to lithium-and manganese-rich ‘layered-layered’ electrodes, such as a lithium-manganese-oxide spinel in a system Li₁₊ₐMn₂-_{a-b}M_{b}O₄, as highlighted by Long et al. in the Journal of the Electrochemical Society, Volume 161, pages A2160-2167 (2014).

Another spinel-related electrode of interest is the lithiated lithium-cobalt-oxide spinel material, Li₂Co₂O₄ (alternatively, LiCoO₂), which has a rock salt stoichiometry. Li₂Co₂O₄ can be synthesized at a relatively low temperature (LT), for example, between 400 and 500° C. as first disclosed by Gummow et al. in the Materials Research Bulletin, Volume 27, pages 327-337 (1992) and in subsequent papers. Lithiated lithium-cobalt-oxide spinel materials such as Li₂Co₂O₄ produced at these temperatures are commonly referred to as LT-Li₂Co₂O₄ (alternatively, LT-LiCoO₂; where “LT” stands for “low temperature”), as is the stoichiometric lithium-cobalt-oxide spinel, LT-LiCo₂O₄ (alternatively, LT-Li_{0.5}CoO₂) that can be derived, for example, by chemical or electrochemical extraction of lithium from LT-Li₂Co₂O₄ (LT-LiCoO₂). Lithiated cobalt-based spinel oxide materials, such as LT-Li₂Co₂O₄, and lithiated Ni-substituted derivatives such as LT-Li₂(Co₁₋ₓ)₂O₄ (0<x≤0.5), for example, LT-Li₂Co_{1.8}Ni_{0.2}O₄ (x=0.1), alternatively LT-LiCo_{0.9}Ni_{0.1}O₂ as disclosed by Gummow et al. in Solid State Ionics, Volumes 53-56, pages 681-687 (1992), are particularly attractive materials relative to stoichiometric spinel materials, such as LiMn₂O₄ (Li_{0.5}MnO₂) or LiCo₂O₄ (Li_{0.5}CoO₂), because the lithiated spinel oxide compounds have a rock salt stoichiometry and structure, like layered LiMO₂ and two-component xLi₂MnO₃·(1-x)LiMO₂ ‘layered-layered’ materials, which may facilitate structural integration of the layered and lithiated spinel components with one another at the atomic level.

The lithiated cobalt-based spinel oxide electrode materials defined above, which include the Ni-substituted derivatives, offer an attractive potential of approximately 3.6 V vs. metallic lithium over the compositional range 0≤x≤0.5 and 1≤y≤2 for Li_{y}(Co₁₋ₓNiₓ)₂O₄, alternatively Li_{y}Co₁₋ₓNiₓO₂ over the compositional range 0≤x≤0.5 and 0.5≤y≤1, which is significantly higher than the potential of approximately 2.9 V that a corresponding lithium manganese-oxide system would offer. Furthermore, cobalt ions tend to have a lower solubility than manganese ions in the organic electrolyte solvents of lithium batteries. Moreover, relative to manganese and nickel ions, cobalt ions have a lower propensity to migrate during electrochemical Co^{3+/4+}redox reactions of lithium-metal-oxide electrodes at high potentials, thereby offering the possibility of mitigating voltage fade of high capacity xLi₂MnO₃·(1-x)LiMO₂ electrodes by embedding a lithiated cobalt spinel component, as disclosed by Lee et al. in Applied Materials & Interfaces, Volume 8, pages 27720-27729 (2016). Nevertheless, despite these advantages, a distinct shortcoming of these lithiated and electrochemically delithiated cobalt-based spinel oxide electrodes (Li_{y}(Co₁₋ₓNiₓ)₂O₄ for 0≤x ≤0.5 and 1≤y≤2) that prevents their use in practical lithium cells and batteries is that they suffer from structural instability and decay when repeatedly charged and discharged, which leads to a poor cycle life and a loss of capacity and energy of the cells and batteries. There is therefore a need to improve the electrochemical stability and performance of lithiated cobalt-based spinel oxide materials for use as cathodes in lithium-ion batteries. The materials described herein address this need.

### SUMMARY OF THE INVENTION

The materials described herein relate specifically to advances that have been made in the compositional design and electrochemical stability of lithiated cobalt-based spinel oxide materials, such as Li₂(Co₁₋ₓ,Niₓ)₂O₄ in which 0≤≤0.5, and particularly for use in a new generation of stabilized ‘layered-layered-spinel’ composite electrode structures in which a stabilized, lithiated cobalt-based spinel oxide component is integrated or embedded within a ‘layered-layered’ xLi₂MnO₃(1-x)LiMO₂ component. Broadly speaking, the cation-stabilized lithium-cobalt-oxide spinel electrode materials in their discharged state, have, in lithiated spinel notation, the general formula Li₂(Co₁₋ₓNiₓ)_{2-2z}M′_{2z}O₄ (0≤x≤0.5; 0<z≤0.5), alternatively Li(Co₁₋ₓNiₓ)_{1-z}M′_{z}O₂ (0≤x<0.5; 0<z≤0.5) in which the Co, Ni and M′ ions together have an average trivalent state. Note that the substitution of one or more aliovalent cations M′, such as divalent Mg or tetravalent Ti for trivalent Co and/or Ni may create oxygen vacancies or cation vacancies, respectively, for charge compensation in these structures. Alternatively, charge compensation can be accomplished by changes to the oxidation state of the Co and Ni cations. In general, when there are oxygen or cation vacancies in the electrode structure, the charge-compensated formulae can be represented as Li₂(Co₁₋ₓNiₓ)_{2-2z}M′_{2z}O_{4-δ}and Li₂(Co₁₋ₓNiₓ)_{2-2z}M′_{2z}O_{4+δ}, respectively, in which δ is typically less than or equal to 0.2, and preferably less than or equal to 0.1. In practice, however, it is extremely difficult to determine precisely the number of oxygen or cation vacancies per formula unit in these materials. For convenience, therefore, the formula Li₂(Co₁₋ₓNiₓ)_{2-2z}M′_{2z}O₄ (or Li(Co₁₋ₓNiₓ)_{1-z}M′_{z}O₂) is used to cover the composition and stoichiometry of the materials, as defined above. The lithiated cobalt and nickel spinel materials described herein include electrochemically charged, lithium deficient electrodes derived from Li₂(Co₁₋ₓNiₓ)_{2-z}M′_{2z}O₄, i.e., Li_{y}(Co₁₋ₓNiₓ)_{2-2z}M′_{2z}O₄ at least over the range 1≤y≤2 (or alternatively Li_{y}(Co₁₋ₓNiₓ)_{1-z}M′_{z}O₂ at least over the range 0.5≤y≤1). Ideally, when y=2, the Li_{y}(Co₁₋ₓNiₓ)_{2-2z}M′_{2z}O₄ material has a lithiated spinel structure with a rock salt stoichiometry in which M′ is selected from one or more metal cations. In principle, the integration of two materials, each having a rock salt stoichiometry and being structurally compatible with one another, such as a lithiated spinel oxide component, Li₂(Co₁₋ₓNiₓ)_{2-2z}M′_{2z}O₄, and a layered component, xLi₂MnO₃·(1-x)LiMO₂ (e.g., M=Ni, Mn, Co) would appear to be more feasible than the structural integration of components having two different structure types such as (i) a stoichiometric rock salt component in which all the octahedral sites are occupied and (ii) a stoichiometric spinel component in which one-half of the octahedral sites and one-eighth of the tetrahedral sites are occupied, the structure of the spinel component therefore containing a significantly higher number of cation defects than the structure of the rock salt component.

The cation-stabilized materials and compositions of formula Li₂(Co₁₋ₓNiₓ)_{2-2z}M′_{2z}O₄ described herein suppress the structural and electrochemical instability of state-of-the art lithiated cobalt-based spinel oxide electrodes such as Li₂(Co₁₋ₓNiₓ)₂O₄. In a preferred embodiment, M′ is selected from one or more stabilizing cations, preferably a trivalent cation such as Al³⁺or Ga³⁺, or a divalent cation such as Mg²⁺, or a tetravalent cation such as Ti⁴⁺and/or Zr⁴⁺, the divalent cation being optionally used in conjunction with a tetravalent ion. Preferably, the range of z is 0<z≤0.5, more preferably 0<z≤0.4, and most preferably 0<z≤0.2, whereas the range of x is preferably 0≤x≤0.5, more preferably 0≤x≤0.3, and most preferably 0≤x≤0.2.

The stabilized, lithiated cobalt-based spinel oxide materials described herein are attractive as positive electrodes for lithium batteries in their own right. Additionally, these materials can be used as a structural component to stabilize a layered metal oxide electrode, or a two-component ‘layered-layered’ metal oxide electrode such as a xLi₂MnO₃·(1-x)LiMO₂ (e.g., M=Mn, Ni, Co) electrode as taught in the art, for example by Thackeray et al. in the Journal of Materials Chemistry, Volume 17, pages 3053-3272 (2007), or a multi-component system containing one or more layered or spinel components. In addition, the M′-substituted materials, particularly those containing trivalent Al and/or divalent Mg ions, have utility in stabilizing the surface of metal oxide electrodes, such as those with layered, spinel and olivine structure types.

In practice, these two-component or multi-component composite structures tend to be highly complex and are not single phase. The structures are inhomogeneous, their inhomogeneity being induced, for example, by cation disorder and they can contain regions with layered character, spinel character, or intermediate layered-spinel character. The structures can also contain regions with stacking faults, yielding complex cation arrangements in the spinel and layered components and in the composite electrode structures overall. In addition, the stabilized lithiated cobalt-based spinel oxide materials may be cation- or anion deficient, or both, leading to deviations from the ideal stoichiometry defined by the formula Li₂(Co₁₋ₓNiₓ)_{2-2z}M′_{2z}O₄.

### BRIEF DESCRIPTION OF THE DRAWINGS

The materials described herein comprise certain novel features and a combination of parts hereinafter fully described, illustrated in the accompanying drawings, it being understood that various changes in the details may be made without departing from the spirit, or sacrificing any of the advantages of the present materials. In these figures, a standard unsubstituted lithiated cobalt oxide spinel, Li₂Co₂O₄, i.e., Li₂(Co₁₋ₓNiₓ)_{2-2z}M′_{2z}O₄ in which x=0 and z=0, which acts as a reference is referred to as LiCoO₂. The M′-substituted materials are referred to as Li(Co₁₋ₓNiₓ)_{1-z}M′_{z}O₂ (x>0, z>0) or LiCo_{1-z}M′_{z}O₂ (x=0, z>0) for simplicity and convenience.

FIG. 1 depicts the powder X-ray diffraction patterns of (a) LiCo_{1-z}Al_{z}O₂for x=0 and z=0 (reference; i.e., LiCoO₂), z=0.05, z=0.10 and z=0.15; (b) corresponding magnified regions of the (440) peak; (c) LiCo_{1-z}Mg_{z}O₂for x=0 and z=0 (reference, i.e., LiCoO₂), z=0.05, z=0.10 and z=0.15; and (d) corresponding magnified regions of the (440) peak; (e) LiCo_{1-z}Ga_{z}O₂ for x=0 and z=0 (reference, i.e., LiCoO₂), z=0.05, z=0.10, z=0.15, and z=0.20; and (f) corresponding magnified regions of the (440) peak.

FIG. 2 depicts the powder X-ray diffraction patterns of (a) LiCo_{1-z}Ni_{z}Al _{δ}O₂ (0.1≤z≤0.25; 0≤δ≤0.15); and (b) LiCo_{1-z}Ni_{z}M′_{δ}O₂M′=Mg, Ga, Ti, Mn (0.1≤z≤0.25; 0≤δ≤0.15).

FIG. 3 depicts the initial charge and discharge voltage profiles of lithium cells with LiCo_{1-z}Al _{z}O₂ electrodes cycled at 15 mA/g between 2.5-4.2 V vs. Li.

FIG. 4 depicts the electrochemical cycling performance of lithium cells with LiCo_{1-z}Al _{z}O₂ electrodes cycled at 15 mA/g between 2.5-4.2 V vs. Li.

FIG. 5 depicts the initial charge and discharge voltage profiles of lithium cells with LiCo_{1-z}Mg_{z}O₂ electrodes cycled at 15 mA/g between 2.5-4.2 V vs. Li.

FIG. 6 depicts the electrochemical cycling performance of lithium cells with LiCo_{1-z}Mg_{z}O₂ electrodes cycled at 15 mA/g between 2.5-4.2 V vs. Li.

FIG. 7 depicts the initial charge and discharge voltage profiles of lithium cells with LiCo_{1-z}Ga_{z}O₂ electrodes cycled at 15 mA/g between 2.5-4.2 V vs. Li.

FIG. 8 depicts the electrochemical cycling performance of lithium cells with LiCo_{1-z}Ga_{z}O₂ electrodes cycled at 15 mA/g between 2.5-4.2 V vs. Li.

FIG. 9 depicts normalized specific capacity plots of LiCoO₂, LiCo_{0.85}Al _{0.15}O₂, LiCo_{0.9}Mg_{0.1}O₂ and LiCo_{0.8}Ga_{0.2}O₂ electrodes cycled at 15 mA/g between 2.5-4.2 V vs. Li.

FIG. 10 depicts the initial charge and discharge voltage profiles of lithium cells with LiCo_{0.9}Ni_{0.1}O₂, LiCo_{0.75}Ni_{0.1}Al_{0.15}O₂, LiCo_{0.8}Ni_{0.1}Ga_{0.1}O₂, and LiCo_{0.8}Ni_{0.1}Mg_{0.1}O₂ electrodes cycled at 15 mA/g between 2.5-4.2 V vs. Li.

FIG. 11 depicts the electrochemical cycling performance of lithium cells with LiCoO₂, LiCo_{0.9}Ni_{0.1}O₂, LiCo_{0.75}Ni_{0.1}Al_{0.15}O₂, LiCo_{0.8}Ni_{0.1}Ga_{0.1}O₂, and LiCo_{0.8}Ni_{0.1}Mg_{0.1}O₂ electrodes cycled at 15 mA/g between 2.5-4.2 V vs. Li.

FIG. 12 depicts normalized specific capacity plots of LiCoO₂, LiCo_{0.9}Ni_{0.1}O₂, LiCo_{0.75}Ni_{0.1}Al_{0.15}O₂, LiCo_{0.8}Ni_{0.1}Ga_{0.1}O₂, and LiCo_{0.8}Ni_{0.1}Mg_{0.1}O₂ electrodes cycled at 15 mA/g between 2.5-4.2 V vs. Li.

FIG. 13 depicts a schematic representation of an electrochemical cell.

FIG. 14 depicts a schematic representation of a battery consisting of a plurality of cells connected electrically in series and in parallel.

### DETAILED DESCRIPTION OF PREFERRED EMBODIMENTS

The stabilized lithiated cobalt-based spinel oxide electrode materials described herein can be represented in their ideal lithiated (rock salt) state by the general formula Li₂(Co₁₋ₓNiₓ)_{2-2z}M′_{2z}O₄, in which M′ is selected from one or more stabilizing multivalent cations, preferably a trivalent cation such as Al³⁺or Ga³⁺, or a divalent cation such as Mg²⁺, or a tetravalent cation such as Ti⁴⁺, Mn⁴⁺and/or Zr⁴⁺, the divalent cation being optionally used in conjunction with a tetravalent ion. Preferably, the range of z is 0<z≤0.5, more preferably 0<z≤0.4, and most preferably 0 <z≤0.2, whereas the range of x is preferably 0≤x≤0.5, more preferably 0≤x≤0.3, and most preferably 0≤x≤0.2. These lithiated spinel materials can be used on their own as positive electrode materials for lithium batteries, or in combination, for example, with a layered or ‘layered-layered’ metal oxide material. The Li₂(Co₁₋ₓNiₓ)_{2-2z} M′_{2z}O₄ material can be blended or physically mixed with one or more layered or spinel components, or they can be structurally integrated with one or more layered or spinel components to form two-component ‘layered-spinel’, three-component ‘layered-layered-spinel’, or multi-component ‘layered-spinel’ systems as defined by the phase diagram and compositional space of each system.

For example, a lithiated spinel of formula Li₂(Co₁₋ₓNiₓ)_{2-2z}M′_{2z}O₄ can be structurally-integrated with a ‘layered-layered’ Li₂MnO₃·(1-x)LiMO₂ structure. As described herein, the terms “structurally-integrated ” and “integrated” as used herein refer to a material with multiple different crystal domains of spinel and/or layered components sharing a common oxygen lattice within a given particle of the material, as opposed to materials that include layered and/or spinel structures that are merely physically combinations or mixtures of separately prepared particulate materials that are mixed together, optionally with a binder, to form an electrode material with separate particles of the different materials (e.g., spinel and layered materials) in close proximity or contact with each other.

In practice, the structures of the composite electrode materials described herein tend to be highly complex and may not be single phase. Typically the structures are inhomogeneous, and the inhomogeneity can be induced, for example, by cation disorder. The structures can contain regions with layered or intermediate layered-spinel character and they can contain regions with stacking faults. The structural complexity of these electrode materials and the variation in their short and long range composition can be varied by varying the synthesis conditions used to prepare them, for example, the firing or annealing temperatures, dwell times and heating and/or cooling rates.

In an ideal layered LiMO₂ rock salt structure all the Li and M cations occupy octahedral sites within a close-packed oxygen array while all the tetrahedral sites are vacant. In contrast, in an ideal LiM₂O₄ spinel structure the Li ions occupy one-eighth of the available tetrahedral sites and the M cations one-half of the available octahedral sites. It is well known in the art that metal oxide materials can often contain a small fraction of cation or anion defects (i.e., vacant sites), for example at grain boundaries such that the formulae LiMO₂ and LiM₂O₄, may not be ideally stoichiometric. The substituted lithiated cobalt-based spinel oxide electrode materials described herein, Li₂(Co₁₋ₓNiₓ)_{2-2z}M′_{2z}O₄ (0≤x≤0.5; 0<z≤0.5), alternatively Li(Co₁₋ₓNiₓ)_{1-z}M′_{z}O₂ (0≤x≤0.5; 0<z≤0.5) can deviate from ideal stoichiometry, and can include some degree of structural disorder in the electrode materials in which the Li, Co and M cations are partially disordered and distributed over the octahedral and tetrahedral sites of the layered and spinel components of the lithium metal oxide structure to form, e.g., a lithiated spinel configuration, a layered configuration, or an intermediate layered-spinel configuration.

The materials described herein are cation-stabilized materials and compositions that suppress the structural and electrochemical instability of lithiated cobalt spinel oxide (Li₂Co₂O₄) and lithiated Ni-substituted derivatives known in the art, such as LT-Li₂ (Co₁₋ₓNiₓ)₂O₄ (0<x≤0.5) electrodes for lithium batteries, notably lithium-ion batteries. In other aspects, the electrodes, electrochemical cells, and batteries that contain such stabilized lithiated cobalt-based spinel oxide electrodes are provided.

The materials described herein can include surface treatments and coatings to protect from undesirable reactions with the electrolyte, for example, treatments or coating of metal-oxide, metal-fluoride or metal-phosphate materials to shield the electrodes from highly oxidizing charging potentials and from other undesirable effects, such as electrolyte oxidation, oxygen loss, and/or dissolution. Such surface protection enhances the surface stability, rate capability and cycling stability of the electrode materials.

In some embodiments, individual particles of a powdered lithium metal oxide composition, a surface of the formed electrode, or both, are coated or treated, e.g., in situ during synthesis, for example, with a metal oxide, a metal fluoride, a metal polyanionic material, or a combination thereof, e.g., at least one material selected from the group consisting of (a) lithium fluoride, (b) aluminum fluoride, (c) a lithium-metal-oxide in which the metal is selected preferably, but not exclusively, from the group consisting of Al and Zr, (d) a lithium-metal-phosphate in which the metal is selected from the group consisting preferably, but not exclusively, of Fe, Mn, Co, and Ni, and (e) a lithium-metal-silicate in which the metal is selected from the group consisting preferably, but not exclusively, of Al and Zr. In a preferred embodiment, the constituents of the treatment or coating, such as the aluminum and fluoride ions of an Al F₃ coating, the lithium and phosphate ions of a lithium phosphate coating, or the lithium, nickel and phosphate ions of a lithium-nickel-phosphate coating can be incorporated in a solution that is contacted with the hydrogen-lithium-manganese-oxide material or the lithium-manganese-oxide precursor when forming the electrodes. Alternatively, the surface may be treated with fluoride ions, for example, using NH₄F, in which case, the fluoride ions may substitute for oxygen at the surface or at least partially within the bulk of the electrode structure.

Preferably, a formed positive electrode comprises at least about 50 percent by weight (wt %) of a powdered lithium metal oxide composition comprising the lithium-rich spinel material, and an electrochemically inert polymeric binder (e.g., polyvinylidene difluoride; PVDF) coated on a metallic current collector (e.g., aluminum). Optionally, the positive electrode can comprise up to about 40 wt % carbon (e.g., carbon back, graphite, carbon nanotubes, carbon microspheres, carbon nanospheres, or any other form of particulate carbon).

The following examples are provided to illustrate certain features and aspects and are not to be construed as limiting the scope of any claims herein. In these examples, a standard unsubstituted lithiated cobalt oxide spinel, Li₂Co₂O₄, i.e., Li₂(Co₁₋ₓNiₓ)_{2-2z}M′_{2z}O₄ in which x=0 and z=0, which acts as a reference, is referred to as LiCoO₂. M′-substituted Li₂(Co₁₋ₓNiₓ)_{2-2z}M′_{2z}O_{4-δ}and Li₂(Coᵢ₋ₓNiₓ)_{2-2z}M′_{2z}O_{4+δ}materials with cation and/or anion vacancies in which z>0, as defined herein, are referred to in normalized notation as LiCo_{1-z}M′_{z}O₂ (x=0) and Li(Co₁₋ₓNiₓ)_{1-z}M′_{z}O₂(x>0) for simplicity and convenience.

### EXAMPLE 1.

### Synthesis and characterization of LiCo_{1-z}M′_{z}O₂(M′=Al , Mg, Ga, Ti, Mn) materials.

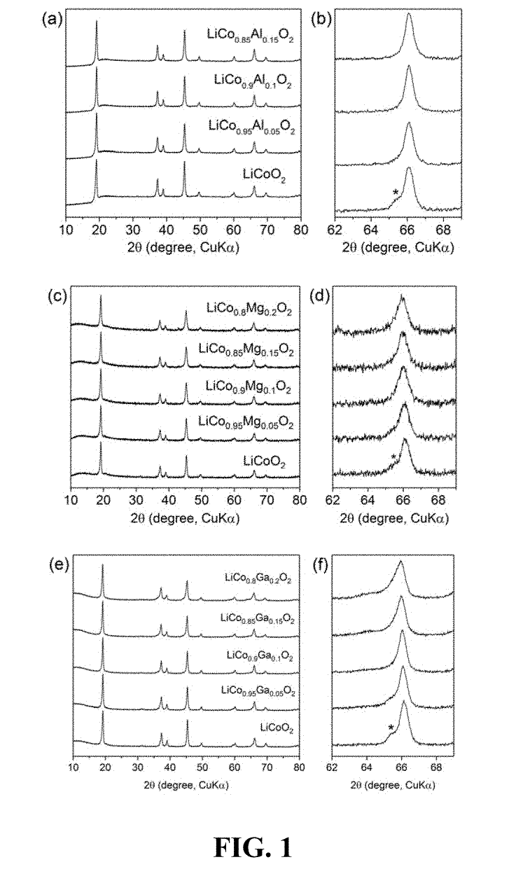

A parent, unsubstituted LiCoO₂ electrode material was prepared by a ‘low-temperature’ method reported previously by Gummow et al. in Mat. Res. Bull. 27, 327 (1992), and U.S. Pat. No. 5,160,712. Cation substituted materials LiCo_{1-z}M′_{z}O₂ (M′=Al , Mg, Ga; 0.05≤z≤0.0.2) were prepared by solid-state reaction of lithium carbonate (Li₂CO₃, >99%) and cobalt carbonate (CoCO₃·˜0.3H₂O, >99%) precursors with either aluminum nitrate (Al(NO₃)₃·9H₂O, >99%), magnesium nitrate (Mg(NO₃)₂·6H₂O, >99%), or gallium nitrate (Ga(NO₃)₃·xH₂O, >99%) precursors. Stoichiometric amounts of the precursors were thoroughly mixed using a mortar and pestle, and fired in air at 400° C. for approximately 6 days. The heating rate was about 2° C. per min, and the samples were cooled in the furnace without controlling the cooling rate. FIG. 1, Panel (a), shows the powder X-ray diffraction (XRD) patterns of the lithiated spinel samples, LiCo_{1-z}Al_{z}O₂, for z=0, 0.05, 0.1, and 0.15. All the XRD patterns could be indexed predominantly to a cubic unit cell consistent with a lithiated spinel structure. There was no apparent evidence of an Al impurity phase, such as Al₂O₃, in this product, indicating that the Al cations had been incorporated into the LiCoO₂ lithiated spinel lattice. Evidence of peak broadening and peak splitting in the XRD patterns, which was particularly noticeable for the unsubstituted LiCoO₂ sample, indicated that the lithiated spinel phase contained some layered character, which is not surprising given the well-known and strong tendency for Co³⁺and Li⁺to order in a layered LiCoO₂ configuration at higher temperatures. Localized layered domains in the lithiated spinel LiCoO₂ product synthesized at 400° C. are clearly evident by the broadening and splitting of the (440) peak, as shown in FIG. 1, Panel (b). In contrast, the magnified (440) peak of the Al-substituted LiCo_{1-z}Al_{z}O₂ cathodes did not exhibit any significant peak splitting. This finding provides strong evidence that Al substitution effectively suppresses the layered ordering of the lithium and cobalt ions and that it stabilizes the spinel configuration in LiCo_{1-z}Al_{z}O₂ lithiated spinel cathode materials, at least those prepared at a relatively low temperature such as 400° C.

The X-ray diffraction patterns of the LiCo_{1-z}Mg_{z}O₂ samples (z=0, 0.05, 0.1, 0.15, 0.2) shown in FIG. 1, Panel (c), are consistent with a lithiated spinel structure. For z=0.15 and 0.2, the onset of small peak at approximately 43°θ may be attributed to a small amount of MgO impurity. As for Al substitution, FIG. 1, Panel (d), shows that Mg substitution suppresses lithium and cobalt layered ordering in the LiCo_{1-z}Mg_{z}O₂ lithiated spinel products.

FIG. 1, Panel (e) shows the X-ray diffraction patterns of LiCo_{1-z}Ga_{z}O₂ samples (z=0, 0.05, 0.1, 0.15, and 0.2) that could be indexed to a lithiated spinel structure. FIG. 1, Panel (f) indicates that the Ga substitution also suppresses layered Li/Co ordering.

Substituted lithiated cobalt spinel oxide materials, Li(Co₁₋ₓNiₓ)_{1-z}M′_{z}O₂ (M′=Al, Ga, Mg, Ti, Mn; 0<x≤0.25; 0<z≤0.2), i.e., those containing nickel, were prepared by the same method as described above, using the appropriate amount of nickel nitrate (Ni(NO₃)₂·6H₂O) precursor required for a desired stoichiometry. For Ti or Mn substitution, TiO₂ nanopowder or MnCO₃ was used as the precursor, respectively.

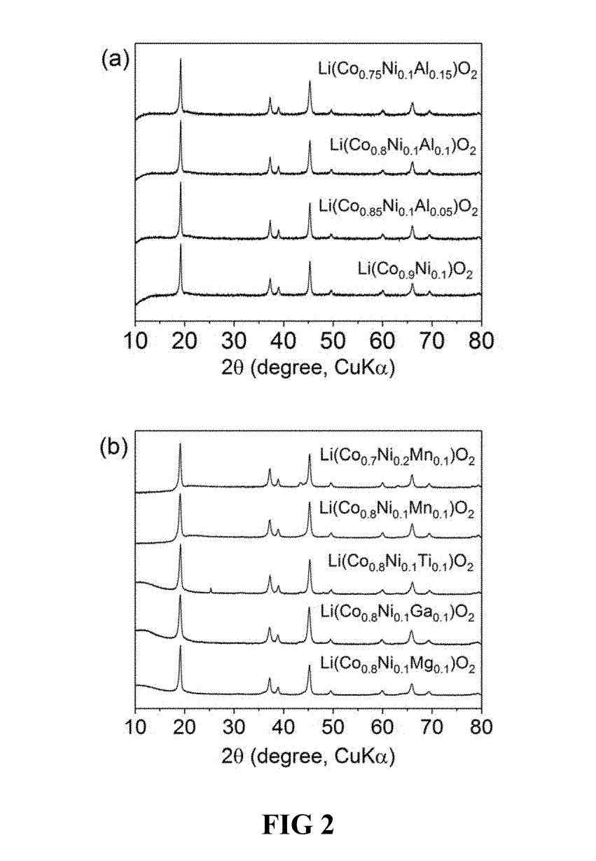

X-ray diffraction patterns of the Li(Co_{0.9-z}Ni_{0.1}Al_{z})O₂ materials (z=0, 0.05, 0.1, and 0.15) are shown in FIG. 2, Panel (a). The patterns could be indexed to a lithiated spinel structure. As for LiCo_{1-z}Al_{z}O₂, there was no apparent evidence of Al and/or Ni impurity phases.

FIG. 2, Panel (b) shows the X-ray diffraction patterns of LiCo_{0.8}Ni_{0.1}M′_{0.1}O₂ (M′=Mg, Ga, Ti, Mn) and LiCo_{0.7}Ni_{0.2}M′_{0.1}O₂ (M′=Mn). All the patterns could be indexed predominantly to a cubic lithiated spinel structure. The XRD pattern of the LiCo_{0.8}Ni_{0.1}Ti_{0.1}O₂ product indicates weak impurity peak at about 25°θ (CuKα), which is tentatively attributed to a TiO₂ impurity phase. The weak peak at about 44°θ in the XRD pattern of LiCo_{0.7}Ni_{0.2}Mn_{0.1}O₂ is attributed to a trace amount of NiO.

### EXAMPLE 2

### Electrochemical evaluations

Coin-type cells (2032, Hohsen) were constructed in an argon-filled glovebox (>5 ppm O₂ and H₂O). The cathode consisted of approximately 84 percent by weight (wt %) of LiCo_{1-z}M′_{z}O₂ powder, 8 wt % carbon, and 8 wt % polyvinylidene difluoride (PVDF) binder on aluminum foil. The anode was metallic lithium foil. The electrolyte was 1.2 M LiPF₆ in a 3:7 (w/w) mixture of ethylene carbonate and ethyl-methyl carbonate. For the cycling experiments, Li/LiCo_{1-z}M_{z}O₂ cells (M=Al and Mg) were galvanostatically charged and discharged between 2.5 and 4.2 Vat a current rate of either approximately 15 mA/g or approximately 60 mA/g. Electrochemical experiments were conducted at about 30° C.

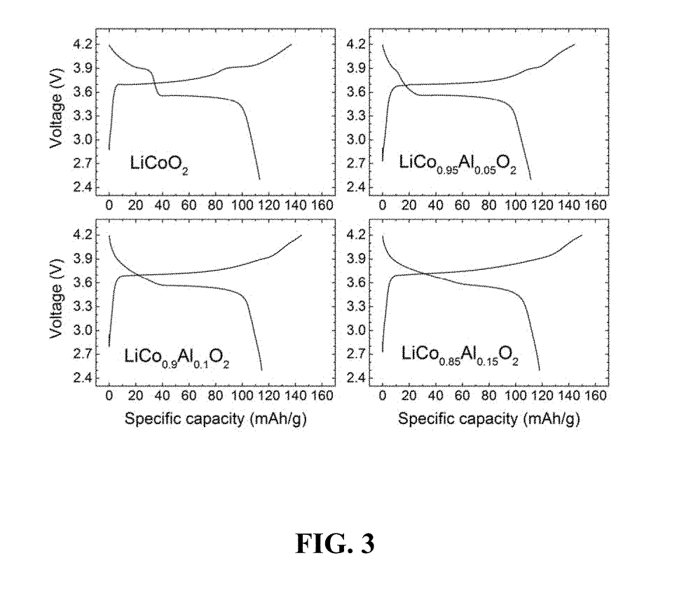

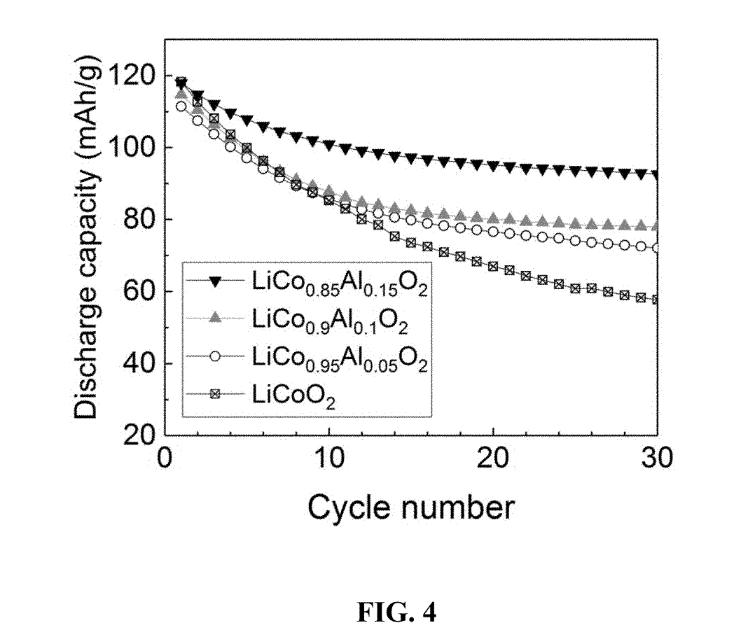

FIG. 3 compares the voltage profiles of the LiCo_{1-z}Al_{z}O₂ lithiated spinel electrodes. With increasing Al content, the 3.9 V plateau that is attributed to local layered domains in lithiated spinel oxide particles disappears and instead, a smoothly sloping voltage profile develops. Such sloping voltage profiles exhibited by the Al-substituted LiCo_{1-z}Al_{z}O₂ lithiated spinel electrodes are advantageous for battery management because it is possible to monitor and estimate the state of charge (SOC) and depth of discharge (DOD) during the operation of practical lithium cells. Furthermore, FIG. 4 demonstrates the improved cycling stability of the Al-substituted LiCo_{1-z}Al_{z}O₂ lithiated spinel electrodes relative to an unsubstituted LiCoO₂ electrode, which is anticipated to be more pronounced when embedded in localized domains in layered LiMO₂ and ‘layered-layered’ xLi₂MnO₃·(1-x)LiMO₂ electrodes.

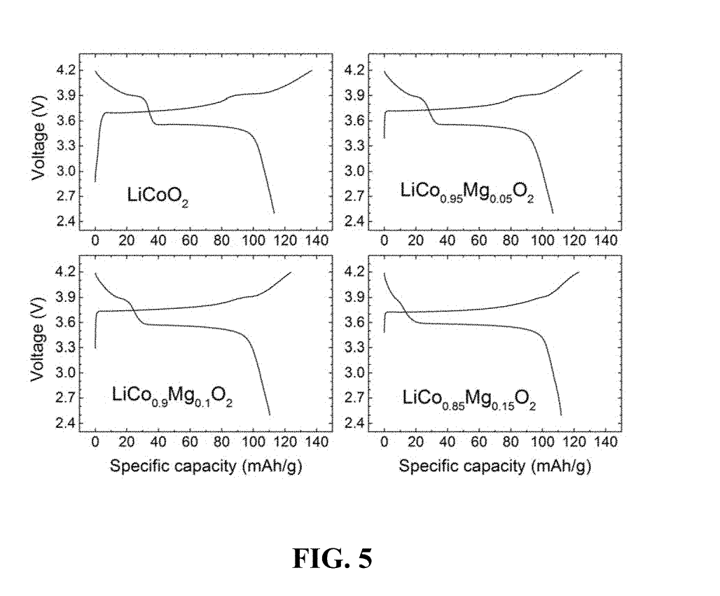

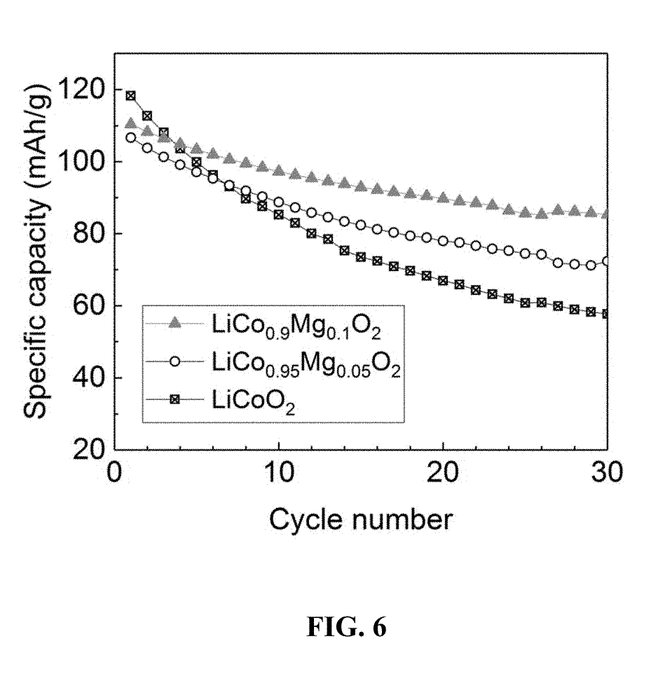

FIG. 5 compares the voltage profiles of the LiCo_{1-z}Mg_{z}O₂ lithiated spinel electrodes for z=0, 0.05, 0.10 and 0.15. As for Al-substituted electrodes, increasing Mg substitution shortens the length of the 3.9 V plateau, implying that the amount of the layered component in the LiCo_{1-z}Mg_{z}O₂ electrode decreases with increasing z, and that at z=0.15, the shape of the electrochemical profile is predominantly spinel-like in character. FIG. 6 demonstrates the improved cycling stability of Mg-substituted LiCo_{1-z}Mg_{z}O_{2-δ}electrodes relative to an unsubstituted LiCoO₂ electrode over 30 cycles.

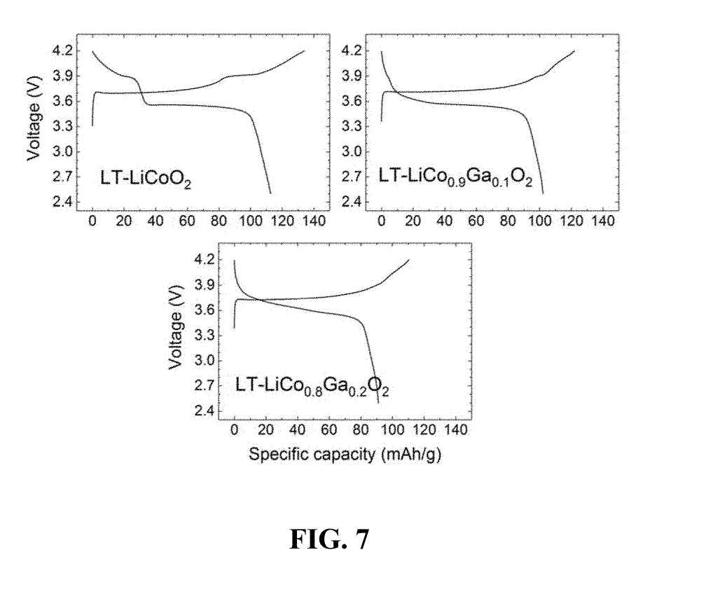

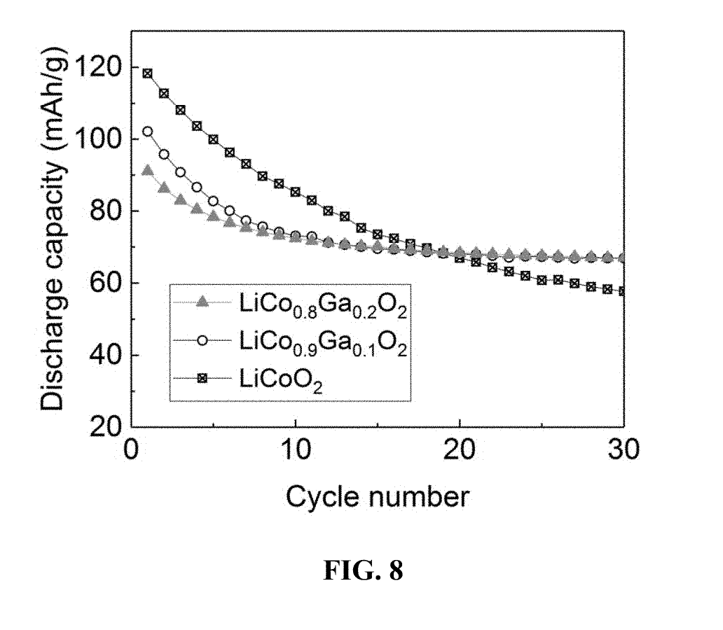

FIG. 7 compares the voltage profiles of the LiCo_{1-z}Ga_{z}O₂ lithiated spinel electrodes for z=0, 0.10 and 0.20. As for Al-substituted electrodes, increasing Mg substitution shortens the length of the 3.9 V plateau, and develops sloping voltage profiles. FIG. 8 demonstrates the improved cycling stability of Ga-substituted LiCo_{1-z}Ga_{z}O_{2-δ}electrodes relative to an unsubstituted LiCoO₂ electrode over 30 cycles.

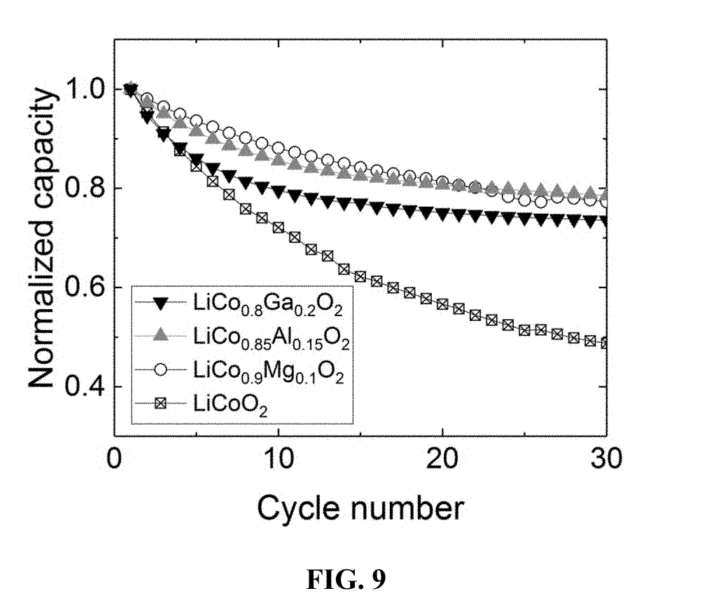

FIG. 9 depicts the normalized specific capacity plots of lithium half cells with LiCoO₂, LiCo_{0.9}Mg_{0.1}O₂, LiCo_{0.85}Al_{0.15}O₂, and LiCo_{0.8}Ga_{0.2}O₂ electrodes cycled at 15 mA/g between 2.5-4.2 V vs. Li. The data highlight the superior cycling stability of materials substituted with Mg, Al, and Ga relative to an unsubstituted LiCoO₂ electrode material.

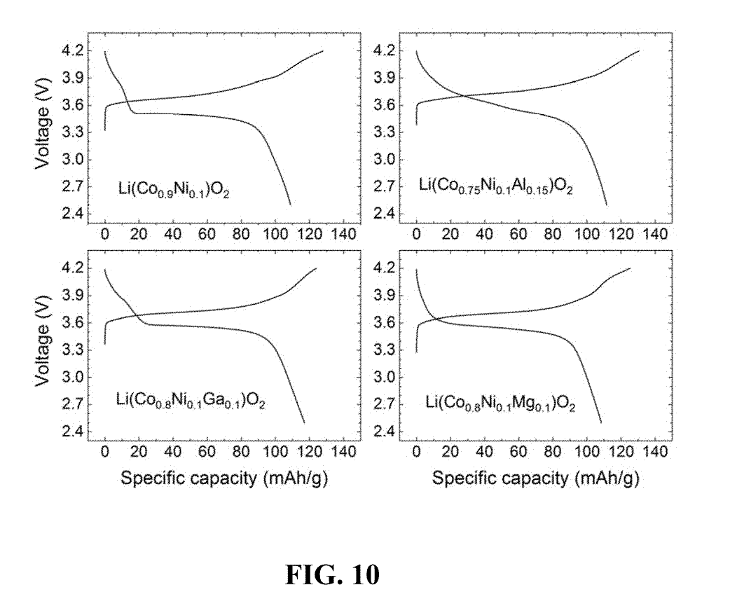

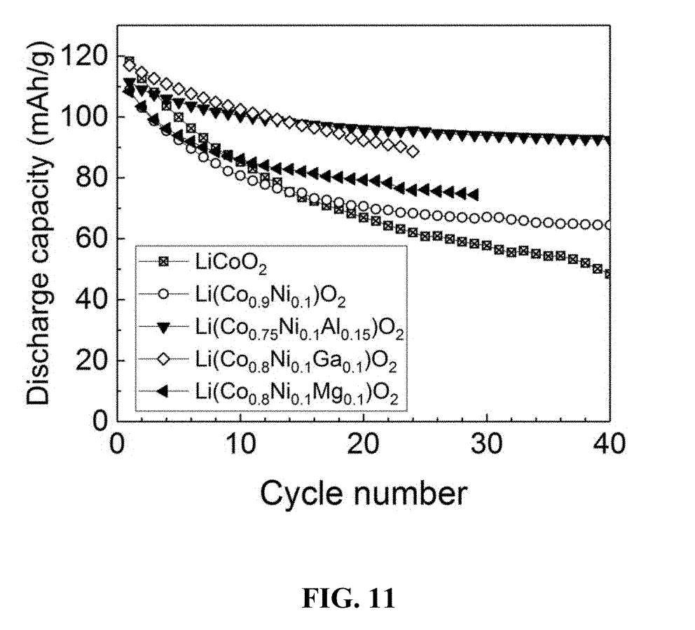

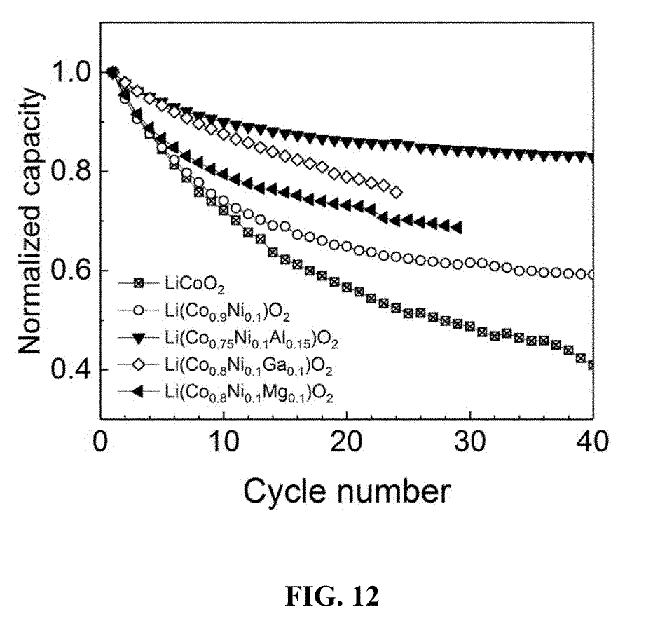

FIG. 10 compares the voltage profiles of the lithium half cells with LiCo_{0.9-z}Ni_{0.1}M′_{z}O₂ lithiated spinel electrodes for M′=Al, Ga, and Mg. All the profiles indicate the electrochemical behavior of Co-based lithiated spinel phase characterized by the reversible redox process at approximately 3.6 V. The development of a sloping voltage profile is most predominant for Al-substitution. FIG. 11 demonstrates that inclusion of Al , Ga, and Mg improve the cycling stability of Li(Co_{0.9}Ni_{0.1})O₂ electrode over 30 cycles. The superior cycling stability of substituted electrode materials comprising Al, Ga, and Mg relative to unsubstituted LiCoO₂ and LiCo_{0.9}Ni_{0.1}O₂ electrodes is further highlighted in the normalized capacity vs. cycle number plot in FIG. 12.

The improved cycling stability of lithiated cobalt and nickel spinel electrode materials that is imparted by substitution of stabilizing M′ cations, such as Al and Mg into the structure as taught herein, renders these materials useful for imparting greater surface stability to an underlying metal oxide electrode for lithium batteries, such as layered (LiMO₂), spinel (LiM₂O₄) or olivine (LiMPO₄) cathodes in which M is typically a first row transition metal ion such as Co, Ni, Mn, Fe). As such, the materials described herein may be used as surface stabilizers for such electrodes, whether in their fully discharged, lithiated state, or in a partially delithiated-, or fully charged state. Thus, in another aspect, an electrode comprises electrochemically-active metal oxide particles comprising a lithiated cobalt and/or nickel spinel electrode material of formula Li₂(Co₁₋ₓNiₓ)₂O₄, Li₂(Co₁₋ₓNiₓ)_{2-2z}M′_{2z}O₄ or Li(Co₁₋ₓNiₓ)_{1-z}M′_{z}O₂ as described herein on the surface of the electrochemically-active metal oxide particles.

### EXAMPLE 3.

### Exemplary electrochemical cell and battery

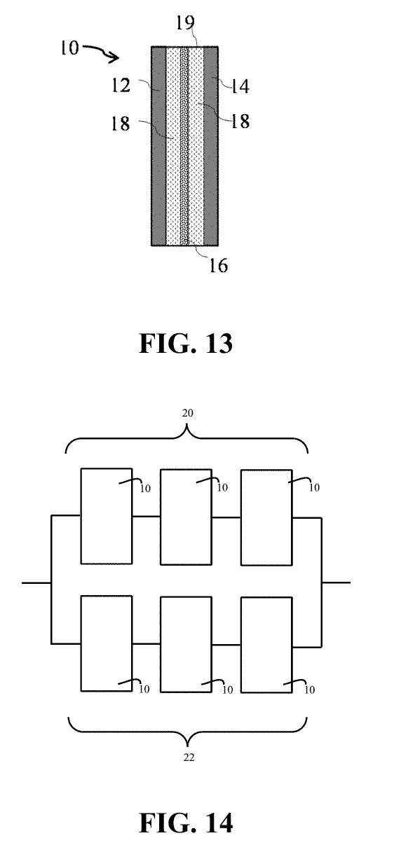

FIG. 13 schematically illustrates a cross-sectional view of lithium-ion electrochemical cell 10 comprising cathode 12, and anode 14, with porous separator 16 therebetween. Electrolyte 18, comprising a solution of a lithium salt in a non-aqueous solvent, contacts electrodes 12 and 14 and separator 16. The electrodes, separator and electrolyte are sealed within housing 19. FIG. 14 schematically illustrates a lithium-ion battery comprising a first cell bank 20 consisting of three series-connected electrochemical cells 10, and a second cell bank 22 consisting of three series-connected electrochemical cells 10, in which first bank 20 is electrically connected to second bank 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing any material, method or device (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of any invention described herein and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments in which an exclusive property or privilege is claimed are defined as follows:

1. A cation-stabilized lithium cobalt oxide electrode material for a lithium electrochemical cell comprising a material of formula: Li₂(Co₁₋ₓNiₓ)_{2-2z}M′_{2z}O₄, having a lithiated spinel structure with a rock salt stoichiometry, wherein M′ comprises one or more metal cations other than cobalt and nickel, 0≤x≤0.5 and 0≤z≤0.5.

2. The electrode material of claim 1, wherein M′ comprises a divalent, trivalent or tetravalent cation.

3. The electrode material of claim 1, wherein M′ is selected from one or more cation of a metal selected from the group consisting of Mg, Al, Ti, Ga, and Zr.

4. The electrode material of claim 3, wherein M′ comprises Al.

5. The electrode material of claim 3, wherein M′ comprises Mg.

6. The electrode material of claim 3, wherein M′ comprises Ti.

7. The electrode material of claim 3, wherein M′ comprises Zr.

8. The electrode material of claim 3, wherein M′ comprises Ga.

9. The electrode material of claim 1, wherein 0<z≤0.4.

10. The electrode material of claim 1, wherein 0<z≤0.2.

11. The electrode material of claim 1, wherein the Li, Co and M′ cations are partially disordered over octahedral and tetrahedral sites of layered and spinel component structures.

12. The electrode material of claim 1, wherein the Li, Co and M′ cations thereof are distributed in a lithiated spinel configuration, a layered configuration, or an integrated layered-spinel configuration.

13. The electrode material of claim 1, wherein the material has a structure that is either cation or anion deficient, or both.

14. The electrode material of claim 1, which is combined with one or more layered or spinel components.

15. The electrode material of claim 1, which is structurally integrated with one or more layered or spinel components in a composite structure.

16. The electrode material of claim 1, which is structurally integrated with a two-component layered-layered material of formula: Li₂MnO₃·(1-x)LiMO₂, wherein M comprises one or more metal cations; and 0<x<1.

17. The electrode material of claim 16, wherein M comprises one or more cations selected of a metal selected from the group consisting of Ni, Mn, and Co.

18. The electrode material of claim 17, wherein the Li, Co, Ni, Mn, M and M′ cations are partially disordered over octahedral and tetrahedral sites of layered and spinel component structures.

19. The electrode material of claim 18, wherein the material has a structure that is either cation or anion deficient, or both.

20. An electrode for a lithium ion electrochemical cell comprising the electrode material of claim 1 supported on a metallic current collector.

21. An electrode for a lithium ion electrochemical cell comprising electrochemically active metal oxide particles supported on a metallic current collector, wherein a surface of at least a portion of said particles comprises the electrode material of claim 1.

22. The electrode of claim 21, wherein the electrochemically active metal oxide is selected from one or more materials having a layered, spinel or olivine structure.

23. An electrochemical cell comprising an anode, a cathode, and a lithium-containing electrolyte contacting the anode and cathode, wherein one or more of the anode and the cathode comprises the electrode material of claim 1.

24. A battery comprising a plurality of electrochemical cells of claim 23, electrically connected in series, in parallel, or in both series and parallel.
